(19) United States
(12) Patent Application Publication
(10) Pub. No.: US 2013/0061827 A1
(43) Pub. Date: Mar. 14, 2013

(54) CYLINDER HEAD SYSTEM AND METHOD OF FORMING SAME

(71) Applicant: Lee B. Moonen, Clarkston, MI (US)

(72) Inventor: Lee B. Moonen, Clarkston, MI (US)

(73) Assignee: GM GLOBAL TECHNOLOGY OPERATIONS LLC, Detroit, MI (US)

(21) Appl. No.: 13/228,506

(22) Filed: Sep. 9, 2011

(51) Int. Cl. F02F 1/24

(52) U.S. Cl. 123/193.5

(57) ABSTRACT

A cylinder head system for an internal combustion engine includes a cylinder head defining an annular port therein having a central longitudinal axis, and a valve seat insert disposed within the port. The valve seat insert includes an outer annular surface configured for abutting the cylinder head and a detection surface concentric with and spaced apart from the outer annular surface. The detection surface has a protrusion thereon extending radially toward the central longitudinal axis. The cylinder head system also includes a valve insertable into the port and configured for translating along the axis during operation of the engine. A method of forming the cylinder head system includes inserting the valve seat insert into the port. After inserting, the method includes removing the protrusion to thereby form an indicator face. After removing, the method includes disposing the valve within the port to thereby form the cylinder head system.

### TECHNICAL FIELD

The present disclosure generally relates to a cylinder head system for an internal combustion engine, and to a method of forming the cylinder head system.

### BACKGROUND

Internal combustion engines generally include a cylinder head defining one or more annular ports. Each annular port may be configured as an intake port for delivering an air/fuel mixture to the internal combustion engine during operation, or as an exhaust port for exhausting combustion products from the internal combustion engine. In addition, a valve may be disposed within each annular port to control the flow of the air/fuel mixture or combustion products. A metal valve seat insert may also be disposed within each annular port to provide a seating surface against which the valve may alternatingly seat and unseat during operation of the internal combustion engine.

For manufacturing efficiency, a given cylinder head having a specific configuration of annular ports may be useful for several variations of internal combustion engine. For example, an internal combustion engine that is assembled to consume gasoline during operation may include a cylinder head having the same configuration as an internal combustion engine that is assembled to consume ethanol during operation. However, because differing fuels may degrade metals at differing rates, each of the aforementioned cylinder heads, although having a similar configuration of annular ports, may require distinct valve seat inserts, e.g., valve seat inserts formed from different materials. Therefore, during assembly of each variation of internal combustion engine, it is important that the correct valve seat insert is paired to the correct cylinder head according to the type of fuel for the internal combustion engine. Similarly, because different types of valve seat inserts may wear at differing rates upon repeated valve contact, it is important that the correct valve is also paired to the correct valve seat insert during assembly of the internal combustion engine.

### SUMMARY

A cylinder head system for an internal combustion engine includes a cylinder head defining an annular port therein having a central longitudinal axis, and a valve seat insert disposed within the annular port. The valve seat insert includes an outer annular surface configured for abutting the cylinder head, and a detection surface concentric with and spaced apart from the outer annular surface. The detection surface has a protrusion thereon extending radially toward the central longitudinal axis. The cylinder head system also includes a valve insertable into the annular port and configured for translating along the central longitudinal axis during operation of the internal combustion engine.

A method of forming a cylinder head system for an internal combustion engine includes inserting a valve seat insert into an annular port having a central longitudinal axis and defined by a cylinder head of the internal combustion engine. The valve seat insert includes an outer annular surface configured for abutting the cylinder head, and a detection surface concentric with and spaced apart from the outer annular surface. The detection surface has a protrusion thereon extending radially toward the central longitudinal axis. After inserting, the method includes removing the protrusion from the detection surface to thereby form an indicator face. After removing, the method includes disposing a valve configured for translating along the central longitudinal axis to contact the valve seat insert during operation of the internal combustion engine within the annular port to thereby form the cylinder head system.

The above features and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic perspective illustration of an internal combustion engine including an engine block and a cylinder head system;

FIG. 2 is a schematic illustration of a bottom view of a cylinder head system for an internal combustion engine;

FIG. 3 is a schematic cross-sectional fragmentary illustration of a cylinder head, valve seat insert, and valve of the cylinder head system of FIG. 2, taken along section lines 3-3;

FIG. 4 is a schematic perspective cross-sectional fragmentary illustration of the valve seat insert of FIGS. 2 and 3, wherein the valve seat insert includes a protrusion;

FIG. 4A is a schematic perspective cross-sectional fragmentary illustration of the valve seat insert of FIG. 4 after the protrusion is removed in accordance with a method of forming the cylinder head system of FIGS. 2 and 3;

FIG. 5 is a schematic perspective cross-sectional fragmentary illustration of another embodiment of the valve seat insert of FIGS. 2 and 3, wherein the protrusion includes a plurality of projections; and

FIG. 5A is a schematic perspective cross-sectional fragmentary illustration of the valve seat insert of FIG. 5 after the plurality of projections is removed in accordance with the method of forming the cylinder head system of FIGS. 2 and 3.

### DETAILED DESCRIPTION

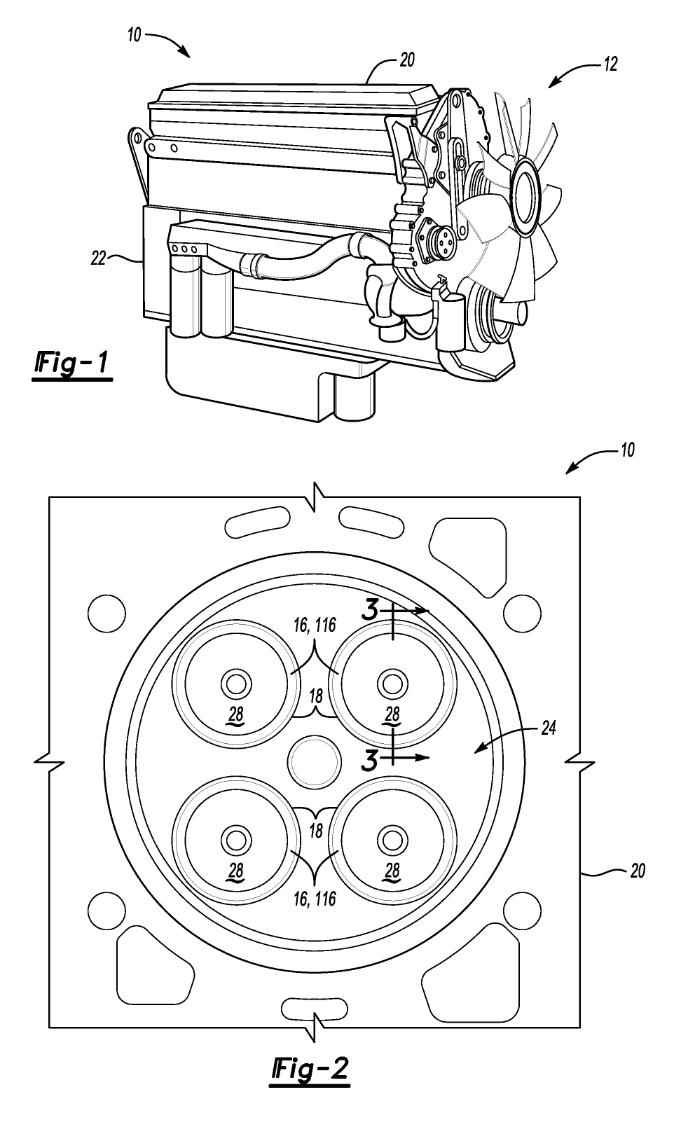

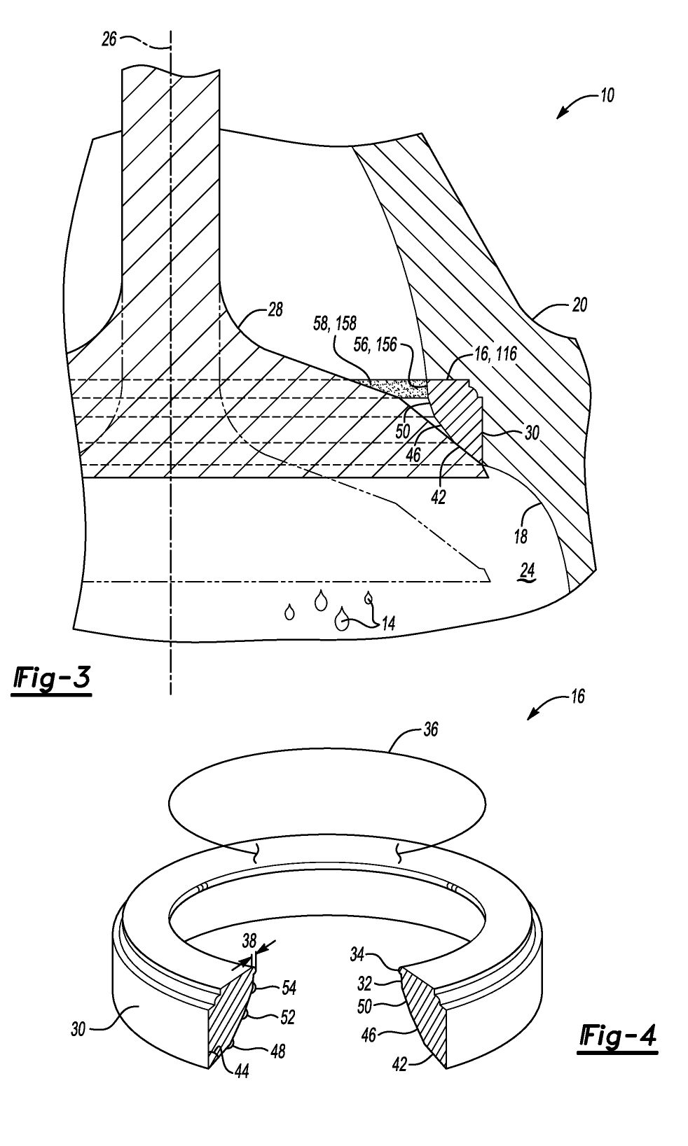

Referring to the Figures, wherein like reference numerals refer to like elements, a cylinder head system 10 for an internal combustion engine 12 (FIG. 1) is shown generally in FIGS. 1 and 2. The cylinder head system 10 may be useful for an internal combustion engine 12 of an automobile, such as a passenger sedan or a truck. However, the cylinder head system 10 may also be useful for non-automotive applications, including internal combustion engines 12 suitable for marine or aviation use. Further, the internal combustion engine 12 may be configured for consuming a type of fuel (shown generally at 14 in FIG. 3) during operation. For example, suitable types of fuel 14 may include, but are not limited to, gasoline, diesel, hydrogen, ethanol, biodiesel, compressed natural gas, organic and/or combustible refuse, propane, methanol, and combinations thereof. A method of forming the cylinder head system 10 is also disclosed.

Referring now to FIG. 2, the method of forming the cylinder head system 10 includes inserting a valve seat insert 16, 116 into an annular port 18 defined by a cylinder head 20 of the internal combustion engine 12 (FIG. 1). By way of general explanation as described with reference to FIG. 1, the cylinder head 20 may attach to an engine block 22 of the internal combustion engine 12 and thereby at least partially define a combustion chamber 24 (FIG. 2) in which a type of fuel 14 (FIG. 3) is combusted during operation of the internal combustion engine 12. The cylinder head 20 may be formed from a metal, e.g., aluminum, and although not shown, may include a plurality of combustion chambers 24 according to the required power output of the internal combustion engine 12.

As shown in FIG. 2, each combustion chamber 24 may include a plurality of annular ports 18. Each of the annular ports 18 may be configured as, for example, an intake port 18 configured for directing a mixture of air and fuel 14 into the combustion chamber 24 during operation of the internal combustion engine 12, or as an exhaust port 18 configured for exhausting combustion products (not shown) from the combustion chamber 24. Further, as best shown in FIG. 3, each annular port 18 has a central longitudinal axis 26.

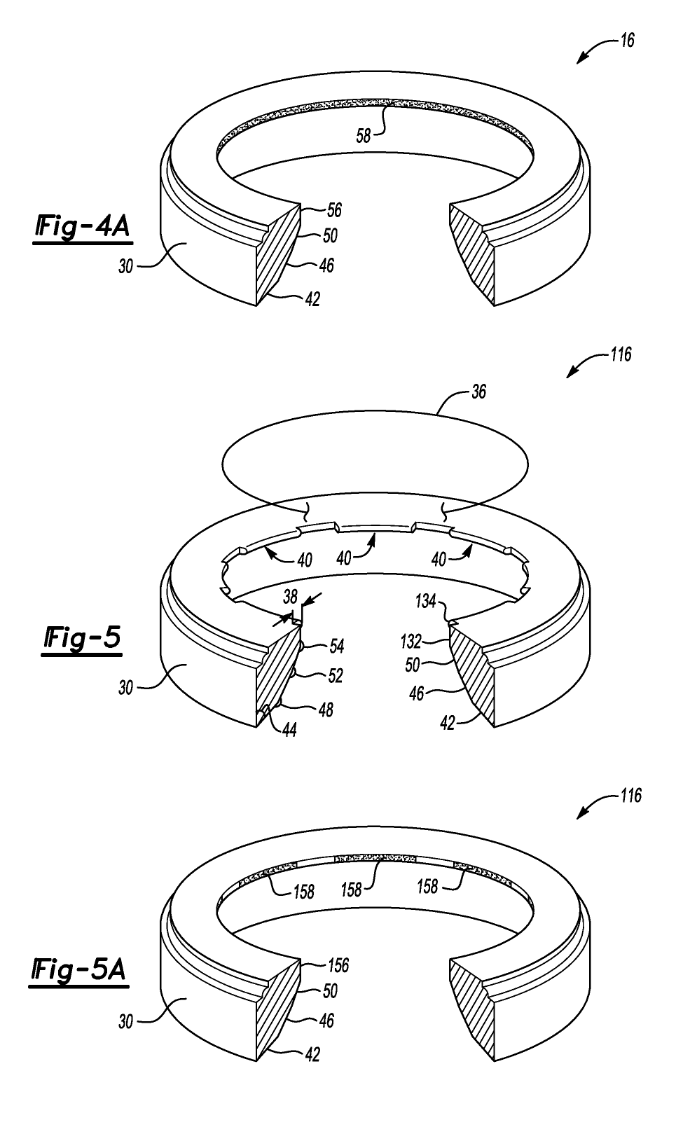

Referring now to FIGS. 2 and 3, the valve seat insert 16, 116 may be a seat for another component, i.e., a valve 28, of the cylinder head system 10 during operation of the internal combustion engine 12 (FIG. 1), as set forth in more detail below. Therefore, the valve seat insert 16, 116 may improve durability and performance of the cylinder head 20 and internal combustion engine 12 by minimizing direct contact between the valve 28 and the cylinder head 20. As shown generally in FIGS. 4 and 5, the valve seat insert 16, 116 is annular or ring-shaped and may be formed from a material having suitable wear and hardness characteristics for operation of the internal combustion engine 12, such as a metal. However, to minimize degradation of the valve seat insert 16, 116 upon exposure to the valve 28 and/or the type of fuel 14 (FIG. 3), the valve seat insert 16, 116 may be formed from a material other than aluminum, e.g., chrome steel.

More specifically, with continued reference to FIGS. 3-5A, the valve seat insert 16, 116 includes an outer annular surface 30 configured for abutting the cylinder head 20 (FIG. 3). Therefore, referring again to the method, and as best shown in FIG. 3, inserting the valve seat insert 16, 116 into the annular port 18 may include disposing the outer annular surface 30 against the cylinder head 20. For example, inserting may include press-fitting the outer annular surface 30 against the cylinder head 20 within the annular port 18 so as to dispose the valve seat insert 16, 116 within the annular port 18 via an interference fit. Therefore, to ensure optimal alignment and fit of the valve seat insert 16, 116 within the annular port 18, the outer annular surface 30 may be substantially parallel to the central longitudinal axis 26.

For the method, the valve seat insert 16, 116 may be inserted within the annular port 18 in any manner. For example, the valve seat insert 16, 116 may be manually press-fit within the annular port 18, or the valve seat insert 16, 116 may be press-fit by machine.

By way of another non-limiting example, inserting the valve seat insert 16, 116 into the annular port 18 may include chilling and/or freezing the valve seat insert 16, 116 before disposing the valve seat insert 16, 116 into the annular port 18. Alternatively or additionally, inserting may include first warming the cylinder head 20 to expand the annular port 18 before subsequently disposing the valve seat insert 16, 116 within the annular port 18.

Referring now to FIGS. 4 and 5, the valve seat insert 16, 116 also has a detection surface 32, 132 concentric with and spaced apart from the outer annular surface 30. That is, the detection surface 32, 132 and the outer annular surface 30 may form opposite surfaces of the valve seat insert 16, 116. The detection surface 32, 132 may or may not be substantially parallel to the outer annular surface 30 and the central longitudinal axis 26 (FIG. 3) when the valve seat insert 16, 116 is disposed within the annular port 18. That is, the detection surface 32, 132 may be substantially parallel to or tapered with respect to the outer annular surface 30. The detection surface 32, 132 may be useful for correctly pairing the valve seat insert 16, 116 to a specific characteristic of the internal combustion engine 12 (FIG. 1), e.g., the type of fuel 14 (FIG. 3), as set forth in more detail below.

With continued reference to FIGS. 4 and 5, the detection surface 32, 132 has a protrusion 34, 134 thereon extending radially toward the central longitudinal axis 26 (FIG. 3). That is, when the valve seat insert 16, 116 is disposed within the annular port 18 (FIG. 3) as set forth above, the protrusion 34, 134 may extend from the detection surface 32 towards the central longitudinal axis 26. In one embodiment, as best shown in FIG. 4, the protrusion 34 is annular and disposed along an entire circumferential length 36 of the detection surface 32. That is, the protrusion 34 may be configured as an annular bump or ridge extending circumferentially along the entire circumferential length 36 of the detection surface 32. Stated differently, the protrusion 34 may be continuous. The protrusion 34 may extend from the detection surface 32 toward the central longitudinal axis 26 for a radial distance 38 of from about 0.1 mm to about 0.4 mm, e.g., about 0.25 mm.

Referring now to FIG. 5, in another embodiment, the protrusion 134 may include a plurality of projections 40 each spaced apart from one another and disposed intermittently along the entire circumferential length 36 of the detection surface 132. That is, in this embodiment, the protrusion 134 may be discontinuous and may include the plurality of projections 40. For example, the protrusion 134 may be configured as a plurality of annular bumps or nubs each extending from the detection surface 132 and spaced apart from one another along the entire circumferential length 36 of the detection surface 132. Each of the plurality of projections 40 may extend from the detection surface 132 toward the central longitudinal axis 26 for a radial distance 38 of from about 0.1 mm to about 0.4 mm, e.g., about 0.25 mm.

For the method, the protrusion 34, 134 and detection surface 32, 132 may be an indicator or guide for correctly pairing the valve seat insert 16, 116 to a specific characteristic of the internal combustion engine 12 (FIG. 1), e.g., the type of fuel 14 (FIG. 3). More specifically, the method may further include detecting the detection surface 32, 132 to thereby identify the valve seat insert 16, 116 as paired to, i.e., compatible with, the cylinder head 20 (FIG. 3) according to the type of fuel 14. That is, the detection surface 32, 132 may be useful as an indicator or guide to alert an operator and/or an optical eye of a component feeding system (not shown) that a specific valve seat insert 16, 116 should be selected and disposed within a particular cylinder head 20 based upon the type of fuel 14 that the internal combustion engine 12 is configured to consume during operation.

For example, detecting may include visually evaluating the detection surface 32, 132 (FIGS. 4 and 5, respectively) to thereby pair the valve seat insert 16, 116 to the cylinder head 20 (FIG. 3) according to the type of fuel 14 (FIG. 3). That is, the operator or optical eye may detect the presence of the protrusion 34, 134 extending from the detection surface 32, 132 so that the valve seat insert 16, 116 may be selected from a queue, storage bin, or feeder for disposal within the annular port 18 of the cylinder head 20 according to the type of fuel 14 of the internal combustion engine 12 (FIG. 1). For example, the operator or optical eye may recognize that only valve seat inserts 16, 116 having the protrusion 34, 134 may be selected for internal combustion engines 12 that are assembled to consume ethanol, while any valve seat insert that does not include the protrusion 34, 134 may only be selected for internal combustion engines 12 that are assembled to consume gasoline. As such, the protrusion 34, 134 and detection surface 32 may signify or indicate a particular type of valve seat insert 16, 116, e.g., a valve seat insert 16, 116 that is compatible with a cylinder head 20 of an internal combustion engine 12 configured for consuming ethanol, so that confusion and/or incorrect component pairings during assembly of the cylinder head system 10 and internal combustion engine 12 may be avoided.

With continued reference to FIGS. 4 and 5, the valve seat insert 16, 116 may further include a first annular surface 42 concentric with and adjoining the outer annular surface 30 to define a first angle 44 therebetween. That is, the first annular surface 42 may abut, and taper with respect to, the outer annular surface 30. Referring again to FIG. 3, such taper may ensure an adequate seal between the valve 28 and the valve seat insert 16, 116 during operation of the internal combustion engine 12 (FIG. 1). The first angle 44 may have a measurement of from about 35° to about 50°, e.g., about 45°.

In addition, as shown in FIGS. 4 and 5, the valve seat insert 16, 116 may further include a second annular surface 46 concentric with and adjoining the first annular surface 42 to define a second angle 48 therebetween that is larger than the first angle 44. For example, the second angle 48 may have a measurement of from about 150° to about 170°. Therefore, although the second annular surface 46 may not abut the outer annular surface 30, the second annular surface 46 may also be tapered with respect to the outer annular surface 30. Such taper may also ensure an adequate seal between the valve 28 and the valve seat insert 16, 116, and may properly align the valve 28 against the valve seat insert 16, 116 during operation of the internal combustion engine 12 (FIG. 1).

Further, as also shown in FIGS. 4 and 5, the valve seat insert 16, 116 may also include a third annular surface 50 concentric with and adjoining the second annular surface 46 to define a third angle 52 therebetween that is smaller than the first angle 44. For example, the third angle 52 may have a measurement of from about 120° to about 140°, e.g., about 130°. Therefore, although the third annular surface 50 may not abut the outer annular surface 30, the third annular surface 50 may also be tapered with respect to the outer annular surface 30. However, as shown in FIGS. 4 and 5, the third annular surface 50 may have a different slope or taper than the taper of the second annular surface 46. Such differing tapers may also ensure an adequate seal between the valve 28 and the valve seat insert 16, 116, and may properly align the valve 28 against the valve seat insert 16, 116 during operation of the internal combustion engine 12 (FIG. 1).

With continued reference to FIGS. 4 and 5, the third annular surface 50 may be concentric with and adjoin the detection surface 32, 132 to define a fourth angle 54 therebetween that is larger than the third angle 52. For example, the fourth angle 54 may have a measurement of from about 155° to about 170°, e.g., about 165°. Stated differently, the third annular surface 50 may join both the second annular surface 46 and the detection surface 32, 132. The third annular surface 50 may also taper from the second annular surface 46 to the detection surface 32, 132. As such, each of the first annular surface 42, the second annular surface 46, and third annular surface 50 may not be substantially parallel to the outer annular surface 30. Stated differently, each of the first annular surface 42, the second annular surface 46, and the third annular surface 50 may be tapered with respect to the central longitudinal axis 26 (FIG. 3) when the valve seat insert 16, 116 is inserted into the annular port 18 (FIG. 3).

Referring again to the method, after inserting the valve seat insert 16, 116 (FIG. 3) into the annular port 18 (FIG. 3), the method includes removing the protrusion 34, 134 (FIGS. 4 and 5, respectively) from the detection surface 32, 132 (FIGS. 4 and 5, respectively). The protrusion 34, 134 may be removed in any suitable manner, such as but not limited to, machining, polishing, cutting, and combinations thereof. For example, for the embodiment described with reference to FIGS. 4 and 4A wherein the protrusion 34 is annular and continuously disposed along the entire circumferential length 36 of the detection surface 32, removing may include machining the protrusion 34 to thereby form an indicator face 56 (FIG. 4A) having a sheen (represented generally by stippling 58 in FIG. 4A). That is, after removing the protrusion 34, the sheen 58 of the indicator face 56 may be annular, continuous along the entire circumferential length 36 of the indicator face 56, and may be distinguishable from a remainder of the valve seat insert 16, e.g., the adjacent third annular surface 50. The sheen 58 may therefore be useful for subsequent error-proofing and verification process operations, e.g., as a visual indicator or guide, during assembly of the cylinder head system 10 and internal combustion engine 12 (FIG. 1), as set forth in more detail below.

Similarly, for the embodiment described with reference to FIGS. 5 and 5A wherein the protrusion 134 includes the plurality of projections 40 each spaced apart from one another and disposed intermittently along the entire circumferential length 36 of the detection surface 132, removing may include machining each of the plurality of projections 40 to thereby form the indicator face 156 (FIG. 5A) having a discontinuous sheen (represented generally by stippling 158 in FIG. 5A). That is, after removing each of the plurality of projections 40, the discontinuous sheen 158 of the indicator face 156 may be discontinuous along the entire circumferential length 36 of the indicator face 156, and form a pattern that is distinguishable from a remainder of the valve seat insert 116, e.g., the adjacent third annular surface 50. The discontinuous sheen 158 may therefore also be useful for subsequent error-proofing and verification process operations, e.g., as a visual indicator or guide, during assembly of the cylinder head system 10 and internal combustion engine 12 (FIG. 1), as set forth in more detail below.

Referring again to the method, as described generally with reference to FIG. 3, the method also includes, after removing the protrusion 34, 134 (FIGS. 4 and 5), disposing the valve 28 within the annular port 18 to thereby form the cylinder head system 10. The valve 28 is configured for translating along the central longitudinal axis 26 during operation of the internal combustion engine 12 (FIG. 1). The valve 28 may be of any type suitable for directing and/or controlling the flow of the aforementioned mixture of air and fuel 14 and/or combustion products (not shown) to and from the combustion chamber 24 of the internal combustion engine 12. For example, the valve 28 may be a poppet valve configured for alternatingly seating against and unseating from the valve seat insert 16, 116 during operation of the internal combustion engine 12.

More specifically, for the embodiment described with reference to FIGS. 4 and 4A wherein the protrusion 34 is annular and continuously disposed along the entire circumferential length 36 of the detection surface 32, the method may further include, after removing the protrusion 34, detecting the sheen 58 (FIG. 4A) to thereby identify the valve 28 as paired to, i.e., compatible with, the valve seat insert 16. That is, the sheen 58 may be useful as an indicator or guide to alert an operator and/or an optical eye of a component feeding system (not shown) that a specific valve 28 may be disposed within a particular annular port 18 in accordance with the valve seat insert 16 that has been previously disposed within the annular port 18.

In one example, detecting may include visually evaluating the indicator face 56 to thereby pair the valve 28 to the valve seat insert 16. That is, detecting may include visually evaluating the sheen 58 to thereby pair the valve 28 to the already-assembled valve seat insert 16—cylinder head 20 pairing according to the type of fuel 14 (FIG. 3), as set forth above. The operator or optical eye may detect the presence of the sheen 58 along the indictor face 56 so that the valve 28 may be selected from a queue, storage bin, or feeder for disposal within the annular port 18 that already includes the previously-selected valve seat insert 16 therein according to the type of fuel 14 of the internal combustion engine 12 (FIG. 1). For example, the operator or optical eye may recognize that the indicator face 56 of the valve seat insert 16 disposed within the annular port 18 has the sheen 58. As set forth above, the sheen 58 may be indicative of, for example, a valve seat insert 16 for an internal combustion engine 12 assembled to consume ethanol. Therefore, based on the presence of the sheen 58, the operator or optical eye may accordingly select a valve 28 compatible with the valve seat insert 16. As such, the sheen 58 may signify or indicate a particular type of valve 28, e.g., a valve 28 that is compatible with a valve seat insert 16 of an internal combustion engine 12 configured for consuming ethanol, so that confusion and/or incorrect component pairings during assembly of the cylinder head system 10 and internal combustion engine 12 may be avoided.

Similarly, for the embodiment described with reference to FIGS. 5 and 5A wherein the protrusion 134 includes the plurality of projections 40 each spaced apart from one another and disposed intermittently along the entire circumferential length 36 of the detection surface 132, the method may further include, after removing the protrusion 134, detecting the discontinuous sheen 158 (FIG. 5A) to thereby identify the valve 28 (FIG. 3) as paired to, i.e., compatible with, the valve seat insert 116. That is, the discontinuous sheen 158 may be useful as an indicator or guide to alert an operator and/or an optical eye of a component feeding system (not shown) that a specific valve 28 should be selected and disposed within a particular annular port 18 in accordance with the valve seat insert 116 that has been previously disposed within the annular port 18.

In one example, detecting may include visually evaluating the indicator face 156 to thereby pair the valve 28 to the valve seat insert 116. That is, detecting may include visually evaluating the discontinuous sheen 158 to thereby pair the valve 28 to the already-assembled valve seat insert 116—cylinder head 20 pairing according to the type of fuel 14 (FIG. 3), as set forth above. The operator or optical eye may detect the presence of the discontinuous sheen 158 along the indicator face 156 so that the valve 28 may be selected from a queue, storage bin, or feeder for disposal within the annular port 18 that already includes the previously-selected valve seat insert 116 therein according to the type of fuel 14 of the internal combustion engine 12 (FIG. 1). For example, the operator or optical eye may recognize that the indicator face 156 of the valve seat insert 116 disposed within the annular port 18 has the discontinuous sheen 158. As set forth above, the discontinuous sheen 158 may be indicative of, for example, a valve seat insert 116 for an internal combustion engine 12 assembled to consume ethanol. Therefore, based on the presence of the discontinuous sheen 158, the operator or optical eye may accordingly select a valve 28 compatible with the valve seat insert 116. As such, the discontinuous sheen 158 may signify or indicate a particular type of valve 28, e.g., a valve 28 that is compatible with a valve seat insert 116 of an internal combustion engine 12 configured for consuming ethanol, so that confusion and/or incorrect component pairings during assembly of the cylinder head system 10 and internal combustion engine 12 may be avoided.

Therefore, referring again to FIG. 3, the cylinder head system 10 for the internal combustion engine 12 includes the cylinder head 20 defining the annular port 18 therein having the central longitudinal axis 26, and the valve seat insert 16, 116 disposed within the annular port 18. The valve seat insert 16, 116 includes the outer annular surface 30 configured for abutting the cylinder head 20, and the detection surface 32, 132 concentric with and spaced apart from the outer annular surface 30. The cylinder head system 10 also includes the valve 28 insertable into the annular port 18 and configured for translating along the central longitudinal axis 26 during operation of the internal combustion engine 12.

Accordingly, the method allows for error-proofing of the cylinder head system 10 during assembly. That is, the method ensures that the valve seat insert 16, 116 is correctly paired to the cylinder head 20 for the internal combustion engine 12 configured to consume a specific type of fuel 14. In addition, the method ensures that the valve 28 is correctly paired to the valve seat insert 16, 116 according to the specific type of fuel 14. More specifically, the detection surface 32, 132 of the valve seat insert 16, 116 allows the valve seat insert 16, 116 to be visually distinguishable during assembly of the cylinder head system 10. Therefore, incorrect pairings of the valve seat insert 16, 116-cylinder head 20 and the valve 28—valve seat insert 16, 116 may be avoided. As such, the cylinder head system 10 and method minimize premature deterioration of the valve seat insert 16, 116 by avoiding interaction between the valve seat insert 16, 116 and incompatible types of fuel 14 during operation of the internal combustion engine 12. Therefore, the cylinder head system 10 and method minimize premature wear of the internal combustion engine 12.

While the best modes for carrying out the disclosure have been described in detail, those familiar with the art to which this disclosure relates will recognize various alternative designs and embodiments for practicing the disclosure within the scope of the appended claims.

1. A cylinder head system for an internal combustion engine, the cylinder head system comprising:
a cylinder head defining an annular port therein having a central longitudinal axis;
a valve seat insert disposed within said annular port and including;
an outer annular surface configured for abutting said cylinder head; and
a detection surface concentric with and spaced apart from said outer annular surface;
wherein said detection surface has a protrusion thereon extending radially toward said central longitudinal axis; and
a valve insertable into said annular port and configured for translating along said central longitudinal axis during operation of the internal combustion engine.

2. The cylinder head system of claim 1, wherein said protrusion is annular and disposed along an entire circumferential length of said detection surface.

3. The cylinder head system of claim 1, wherein said protrusion includes a plurality of projections each spaced apart from one another and disposed intermittently along an entire circumferential length of said detection surface.

4. The cylinder head system of claim 1, wherein said valve seat insert further includes a first annular surface concentric with and adjoining said outer annular surface to define a first angle therebetween.

5. The cylinder head system of claim 4, wherein said outer annular surface is substantially parallel to said central longitudinal axis.

6. The cylinder head system of claim 4, wherein said valve seat insert further includes a second annular surface concentric with and adjoining said first annular surface to define a second angle therebetween that is larger than said first angle.

7. The cylinder head system of claim 6, wherein said valve seat insert further includes a third annular surface concentric with and adjoining said second annular surface to define a third angle therebetween that is smaller than said first angle.

8. The cylinder head system of claim 7, wherein said third annular surface is concentric with and adjoins said detection surface to define a fourth angle therebetween that is larger than said third angle.

9. The cylinder head system of claim 7, wherein each of said first annular surface, said second annular surface, and said third annular surface is not substantially parallel to said outer annular surface.

10. The cylinder head system of claim 1, wherein said cylinder head is formed from aluminum and said valve seat insert is formed from a material other than aluminum.

11. A method of forming a cylinder head system for an internal combustion engine, the method comprising:
inserting a valve seat insert into an annular port having a central longitudinal axis and defined by a cylinder head of the internal combustion engine, wherein the valve seat insert includes;
an outer annular surface configured for abutting the cylinder head; and
a detection surface concentric with and spaced apart from the outer annular surface, wherein the detection surface has a protrusion thereon extending radially toward the central longitudinal axis;
after inserting, removing the protrusion from the detection surface to thereby form an indicator face; and
after removing, disposing a valve configured for translating along the central longitudinal axis to contact the valve seat insert during operation of the internal combustion engine within the annular port to thereby form the cylinder head system.

12. The method of claim 11, wherein the internal combustion engine is configured for consuming a type of fuel, and wherein the method further includes detecting the detection surface to thereby identify the valve seat insert as paired to the cylinder head according to the type of fuel.

13. The method of claim 12, wherein detecting includes visually evaluating the detection surface to thereby pair the valve seat insert to the cylinder head according to the type of fuel.

14. The method of claim 11, wherein the protrusion is annular and disposed along an entire circumferential length of the detection surface, and further wherein removing includes machining the protrusion such that the indicator face has a sheen.

15. The method of claim 14, further including, after removing, detecting the sheen to thereby identify the valve as paired to the valve seat insert.

16. The method of claim 15, wherein detecting includes visually evaluating the indicator face to thereby pair the valve to the valve seat insert.

17. The method of claim 11, wherein the protrusion includes a plurality of projections each spaced apart from one another and disposed intermittently along an entire circumferential length of the detection surface, and further wherein removing includes machining each of the plurality of projections such that the indicator face has a discontinuous sheen.

18. The method of claim 17, further including, after removing, detecting the discontinuous sheen to thereby identify the valve as paired to the valve seat insert.

19. The method of claim 11, wherein the valve seat insert further includes;
a first annular surface concentric with and adjoining the outer annular surface to define a first angle therebetween;
a second annular surface concentric with and adjoining the first annular surface to define a second angle therebetween that is larger than the first angle; and
a third annular surface concentric with and adjoining the second annular surface to define a third angle therebetween that is smaller than the first angle, wherein the third annular surface is concentric with and adjoins the detection surface to define a fourth angle therebetween that is larger than the third angle; and
further wherein inserting includes disposing the outer surface in contact with the cylinder head.

20. The method of claim 11, wherein the valve is a poppet valve configured for alternatingly seating against and unseating from the valve seat insert during operation of the internal combustion engine.
